(19) United States
(12) Patent Application Publication
(10) Pub. No.: US 2002/0116450 A1
(43) Pub. Date: Aug. 22, 2002

(54) Network for information transfer for mobile stations

(75) Inventors: Winston Ser Tuen Wei, Singapore (SG); Eugene Peng Koon Ghe, Singapore (SG)

Correspondence Address: GREER, BURNS & CRAIN, LTD., 300 S. Wacker Drive - Suite 2500, Chicago, IL, 60606, US

(73) Assignee: Multiscience System Pte Ltd.

(21) Appl. No.: 09/803,861

(22) Filed: Mar. 12, 2001

Related U.S. Application Data
(60) Provisional application No. 60/250,673, filed on Dec. 1, 2000.

(51) Int. Cl. G06F 15/16; G06F 17/60

(52) U.S. Cl. 709/203; 709/246; 705/26; 705/44; 707/104.1

(57) ABSTRACT

Search templates for a web portal search engine of the internet are provided. Each said template is capable of use by a mobile user, each said template being in the form of a search index card capable of use to compose an alphanumeric message for broadcast, and capable of use for interpreting a received message, by the mobile user on a mobile phone, said message being transmitted through a mobile phone network and a server gateway, with electronic transfer of a message to (and from) the said search engine, there being no need for the mobile user to have an internet address of a mobile phone.

### DESCRIPTION OF USE

The present invention generally relates to a method and system for sending and retrieving information from the internet over a mobile network to a mobile phone. Generally the method and system can be used for both secure and non secure sending/receiving and permits the channelling of consolidated data to a webserver on the internet.

### BACKGROUND OF INVENTION

After the proliferation of Internet eCommerce, another wave of communication has also arisen, called “mCommerce” (mobile commerce). This form of communication is very similar to surfing the Internet for eCommerce, but instead of a personal computer and modem a WAP phone, connected to the telecommunications provider's WAP-enabled gateway for a connection to access websites, is used. These phones and WAP gateways use WML (Wireless Markup Language). This requires customers to login to their respective telephone networks and customers are charged based on the hours of connectivity. Furthermore, there is a monthly subscription fee.

The Short Message Service (SMS) is the ability to send and receive text messages to and from mobile telephones. The text can comprise words or numbers or an alphanumeric combination. SMS was created when it was incorporated into the Global System for Mobiles (GSM) digital mobile phone standard.

A single short message can be up to 160 characters of text in length using default GSM alphabet coding and 140 characters when USS2 international character coding is used.

GSM is an international standard for digital mobile telephones. In Europe and Asia, a mobile telephone can be modified to work in any country in the region. GSM requires a transmitter every five kilometers, so it is not entirely suitable for low-population areas like America and Africa. SMS messages can be transmitted and/or received on a GSM telephone display. Normally SMS can be used to let the mobile user interact with the internet for a number of activities, for example email, news headlines, traffic reports etc. GSM also provides a digital data line at 9600 bps which can be connected to compatible equipment without the need for a modem.

From the point of view of the user of a mobile phone for a connection to the internet it is apparent from this system that for uplinks and downloads from the internet to a mobile phone or a mobile receiver, it is necessary to use the gateway of the telecommunication provider. However telecommunication providers and users of the internet do not always use compatible protocols, creating problems for transactions and information transfer when a mobile user wants to download or upload from sites on the internet.

From the point of view of retailers using the internet there is an extremely limited amount of information that can be downloaded from the internet to a mobile user through the telecommunication service provider. The same problems of protocol compatibility also exist. Some aspects of these two concurrent problems have been addressed to date.

For example, in U.S. Pat. No. 5,946,629 (Sawyer) a message communications system for internet intra-network messages is disclosed. The message center for the cellular network includes functionality for processing received messages and forwarding these to other connected networks. The protocol of the messages is established so that a destination identifier is used, permitting speedy forwarding of the message to the desired destination of the sender. The center functionality permits communications to be speeded up between cellular networks (using SMS messaging format), conventional telephone networks and Wide or Local Area Networks (in email format).

However, much of the work done in the message center needs manual interaction or supervision and also requires the message center to be part of a cellular network, thus being intimately connected with the telecommunication service provider.

U.S. Pat. No. 5,159,592 (Perkins) provides apparatus and a method for managing transmissions in both directions between a wired network and at least one mobile communication unit. The unit is in wireless communication with the wired network. Each user is assigned a unique network address (for example, TCP/IP protocol address). A local gateway is coupled with a wireless Local Area Network and the wired network for communication with the mobile unit.

While this may remove the problem for the mobile user of requiring use of the telecommunications server gateway, it does not address the problem of the ability of the mobile user to actively interact with the internet in a format that is both readable and interactive at the user end.

U.S. Pat. No. 5,353,331 (Emery) addresses some of these problems, but with reference to each mobile subscriber's home location register. U.S. Pat. No. 5,603,081 provides a system for sending paging messages and packets of information to and from a remote station, but not interactive communication.

U.S. Pat. No. 5,915,222 (Olsson) relates to a SMS communications network but does not address the question of interaction from the mobile with the internet.

Various other disclosures have been made regarding aspects of the interconnection between mobile phones and the internet or between a wireless network and the internet. Examples of these can be seen in U.S. Pat. No. 5,661,516 and U.S. Pat. No. 6,097,961.

More recently specific problems with interfacing between mobile phone users and the internet have been addressed. For example, U.S. Pat. No. 6,125,281 (Wells) addresses the problem of a mobile user wishing to interface with a PC through the internet, where the PC may be switched off or disconnected from the internet part way through the activity. A method is disclosed for operating the mobile station with bi-directional communication with a base station and a mobile switching center. A database is provided within the switching center that is bi-directionally coupled to the mobile center and to the internet or other functions. The information is stored in the database if it cannot be sent immediately and sent as soon as the end user is back online/free.

However this does not address the difficulty that the mobile phone does still not provide an interactive system between the mobile phone and the internet.

U.S. Pat. No. 6,078,820 (Wells) addresses some aspects of the problem within the interactivity between a mobile telecommunication system and other systems, principally the internet, by addressing the format of SMS messages. The patent discloses a method of electronically determining if the SMS message has a first or a second transfer format. If the message has a first transfer format the message is processed in a conventional manner. If the SMS message has the second transfer format the message is passed to locate an application identifier entry. If the mobile station supports that application identifier entry then the message is forwarded unchanged. If the application identifier is not supported by the mobile phone the data entry of the SMS message is processed and displayed with a first display format.

If the application identified is present the data is displayed with the second display format specified by the application.

Thus while this method permits determining whether or not the message can be translated into a readable form for one particular cell phone, does not necessarily provide a universal method without the requirement for further translation into or from other systems' protocols.

In WO 0072612 an aspect of the above problem is addressed. The invention disclosed is to a system and method for providing information to a mobile phone in response to a request for such service from a communication device. The user of the mobile phone can dial a service requesting information be forwarded to it. This can be initiated either by inputting digits on the mobile station, or by the use of a micro-browser in the mobile. The input triggers an SMS message, which is sent to a wireless web information service gateway. The gateway acts as a service provider/manager and retrieves the requested information from one or more sources. This information is forwarded via a SMS message or a micro-browser and stored according to a pre-selected format within the mobile station.

However, the wireless web information service gateway requires that the information requested be in accordance with a predetermined profile for that user and for a particular profile of information requested. This has to be pre-programmed for the gateway in order to be useable. Further, it requires the programming of the mobile station or the requirement that the mobile station have a micro-browser. Some mobile stations are not pre-programmable in this manner and do not have an associated micro-browser. Thus, for such mobile stations the application could not be used.

A proposed telecommunication system, the Universal Mobile Telecommunication System (“UMTS”), is a proposed system for addressing problems in this field. It is proposed that such a system will enable the delivery of high-value broadband information to mobile users via wireless or satellite networks. Such systems are now in field trials. It is proposed that it will enable delivery of pictures, graphics, video communication and other wide-band information. UMTS will also assist in the delivery of voice and data information to mobile stations. However, the system is experiemental, will require additional hardware and software for use with a mobile station, and is not operable without this.

It is therefore an object of this invention to provide protocols and engines for interactive use of a mobile station and the internet, which do not necessarily require WAP protocols, but which can be used in conjunction with SMS. It is a further object of this invention to provide such an interactive system that implements the use of a mobile station for such activity, irrespective of location.

It is a further object of this invention to provide a system and method for mobile inter-communication/activity between a wireless network and the internet. It is a further object of this invention to provide a system and method for wireless communication and interactive use of the internet irrespective of the telecommunication service provider.

### SUMMARY OF INVENTION

The foregoing and other problems are overcome and the objects of the invention are realised by systems and methods in accordance with embodiments of this invention.

The present invention addresses the difficulties of the lack of uniformity of protocols for a mobile station user to interact with the internet.

The present invention provides search templates for a web portal search engine of the internet, each said template being capable of use by a mobile user, each said template being in the form of a search index card capable of use to compose an alphanumeric message for broadcast by the user via mobile phone to a server gateway, there being no need for the mobile user to have an internet address.

Optionally, each template can be printed, where a mobile user is connected to a printer. Also, the templates can be printed from the internet at a fixed station and then used by a mobile user when mobile.

Optionally, the present invention further provides search templates for a web portal search engine, wherein said templates are for use as a web search template.

Optionally, the search messages are sent on the GSM network to the mobile operator's SMS gateway, thence to an SMS server for on-forwarding to the Internet. The protocols between the SMS gateway and SMS server, and the SMS server and the Internet, are all the same, and optionally, TCP/IP protocols are used.

Optionally, the SMS server is also the web server for the web portal. Such a web server is equipped with SQL database to hold the information relating to the portal and the mobile users. There is thus no requirement that HTML coding be known to the mobile user.

In this manner the search template used by the end user can be one that permits the mobile user to use the template for updating, modifying, deleting, or adding webpage content.

There is thus no requirement that HTML coding be known to the mobile user.

Optionally, different types of functions and searches can use different search indexes or templates. For example, a search for a shop or e-Commerce site though which to place a particular order can be provided on one type of search index. A second search index can be provided for the mobile user requesting map instructions.

For the above example of an ordering search index, the SMS template can be filled out, and sent by mobile via the SMS gateway to the SMS server. The SMS server then uses an internet connection of known type to facilitate the order search over the Internet.

Once results are forwarded to the mobile user from the SMS gateway, the mobile user can use the templates for further queries within the results or to move onto another search.

One or more e-Commerce sites on the internet can also use the SMS server for downloading information and requests to a mobile user. For example, a company may establish a search template for questions it requires answers to, which template can be downloaded via the SMS server and SMS gateway to one or a number of mobile users.

Additionally, the SMS server can be used to process material to some extent before downloading to the mobile user. Additionally, the template can be used to encode a particular level of security, desired by the mobile user. The SMS message can encode the information with that level of security, regardless of where the message is on-forwarded to.

The advantage of this system is that there is one protocol with SMS for a mobile user to interact with all the internet from a mobile station. With useable/printable templates, the job of composing short messages in a manner that is meaningful on the internet, can be effected quickly and easily by a mobile user, without need for memorization of any details. Further, the system permits the use of the templates in any area, irrespective of the country in which the company the mobile user is sending to or receiving from is based.

### BRIEF DESCRIPTION OF DRAWINGS

Further aspects of the present invention will become apparent from the following description which is given by way of example only and with reference to the accompanying drawings in which:

FIG. 1 is a diagrammatic representation of the system of the present invention; and

FIG. 2 is a diagrammatic representation of an example of the method of the present invention;

FIG. 3 is a flow chart of another example of the method of the present invention.

### DETAILED DESCRIPTION

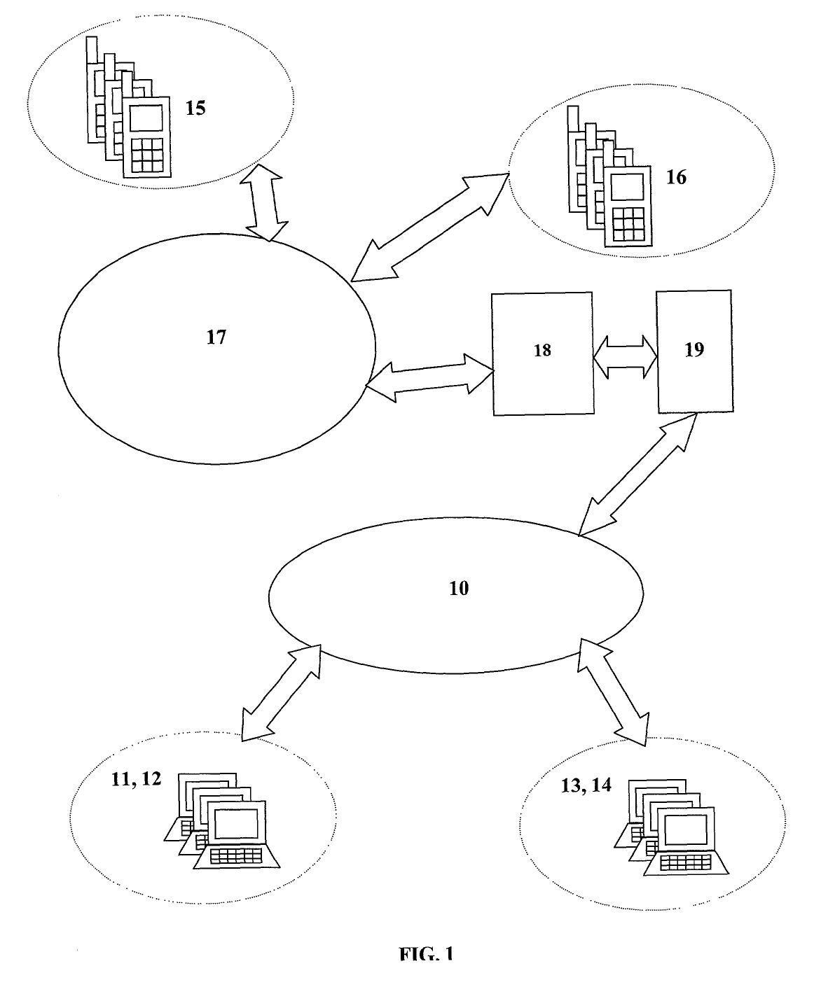

Referring now to FIG. 1, there is shown a diagrammatic representation of a series of networks for implementing the system of the present invention. The internet is generally represented by the numeral 10. The internet (10) includes connections to corporate users and customers in a first country (11, 12 respectively, and country A), and corporate users and customers in a second country (13, 14 respectively and country B) all being of known type. All users (11-14) are generally denoted by use of a fixed computer system and modem for inter-connection to the internet (10) and may themselves be on a LAN and/or a WAN.

Mobile users in two countries (respectively 15, 16 in countries B and C) maybe using mobile stations for any or all of the functions of:

placing purchase orders through the internet (10);

downloading information to a site on the internet (10); and/or

uploading information to a site on the internet (10).

The station is generally a digital mobile phone of known type.

Such end sites (including sites 11-14) can be in any country (A, B or C). The mobile user (15, 16) is connected to a GSM network (17), and uses SMS on that network (17) to connect with the mobile operator's SMS gateway (18). Connection between the SMS gateway and the SMS server (19) is in the frame of TCP/IP protocols. The SMS server (19) is connected to the internet (10) within a framework of TCP/IP protocols.

Each SMS server (19) generates one or more templates which can be printed out by the mobile user (15, 16) or used without the need for printing, as is desired. The instructions on the template are used to compose a search message. The search message is sent via SMS to the SMS gateway (18), onto the SMS server (19) (etc) in known manner. The SMS server (19) returns the results of the search in a single SMS message. The mobile user (15, 16) can then uses the SMS format to query the SMS server (19) for more results or subsequent searches.

The template can also include instructions which can be coded for the SMS server (19) as to how the message or the content of the template is to be on-forwarded. For example, a simple numeric coding can be used to direct to the SMS server (19) to on-forward the SMS via email, SMS or a video link, etc. The SMS message can be coded for security, as is desired. The coding can include encryption, of known type, and can be added to the message for use regardless of where the message or information from the message is on-forwarded to. Similarly templates for downloading information to the mobile users (15, 16) can incorporate security.

While the example given is the use of a template to format searches for the SMS server (19) to process, it will be appreciated that the template may be differently structured so that the mobile user (15, 16) can, for example, order services or goods over the internet (10), request a personal follow-up, etc.

Similarly, it will be appreciated by those skilled in the art that the users (11-14) of the internet may also structure a template for downloading information or requests for information via the SMS server (19) to the end user (15, 16). Such template could form part of a survey; could include advertising, and so on. The end users (15, 16) can either complete the template and return an SMS message, or act on the information received via the template, as is desired.

The above described system will be further described with reference to the following examples.

### EXAMPLE ONE

A sports club has members and obviously wishes to look for new members. Existing members or new members, after registration, (can through the method of the invention) receive updates via mobile phones on such matters as: broadcast email, amendments to game schedules, up to date changes for games and team, club specials and special offers available to club members only.

The club might otherwise use traditional means such as club notice boards, or broadcast media (newspaper, television, etc) to advise club members of these special offers or these updates. Once club members are advised, any offer or update can either be reviewed and returned via coupons in printed media or members can request and obtain coupons via the internet or SMS through the method of the present invention.

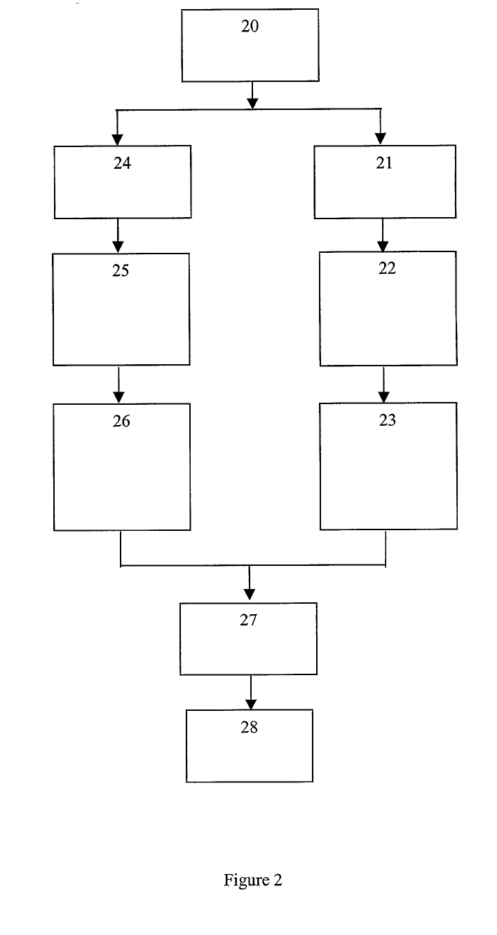

Referring to FIG. 2, when members (20) redeem the e-coupons via SMS these can be redeemed through the mobile system (21-23) and confirmed through a simple procedure within the club administration. The club's online e-marketing (24) confirms the password of the day, through email and SMS (25) that the e-coupons can be redeemed as the correct message of the day password has been used by the member (20) by the member's ID or name (26). The member (20) can through SMS and the method of the present invention make payment (27) and arrange pickup for delivery (28).

The example given above is a sporting club, which also uses the SMS system for selling goods or services to its members, in addition to other information. However, it will be appreciated that any organisation may use this structure. It need not be a club. The members (20) could be customers of a company or a retailer. The items on offer could represent goods or services.

### EXAMPLE TWO

The second example is that of using the method and system of the invention for hunting for an apartment/accommodation. Once registration has occurred with a service or company and that company has the customer details, online forms can be collected for a single information request by the SMS system of the invention. A template of the type in accordance with the present system can be used to submit the criteria for the property looked for. Tables 1 and 2 set out examples of such templates and the resultant coded message that can be sent the SMS, so that the information regarding available accommodation that fulfills the requirements can be downloaded to a mobile station.

The template is filled out (either mentally or manually) and coded as set out in Table 1, Table 2. Table 3 sets out the reply, which can then be decoded using the material on the template. For example, as shown in the Tables, the mobile user is looking to see what is available as a three-bedroom flat or apartment located in a specified “area”. The message set out in Table 2 is composed and Table 3 shows the specific listings that come back, which can be interpreted with the use of the template from Table 1. Thus listings can be made with much less detail and can be downloaded through a mobile network while the mobile user out looking at property. The internet based company (13, FIG. 1) through the SMS server (19) can also track who the enquirer is and be able to follow up directly on the request in an efficient manner.

Security can be added to all such examples in known manner. The mobile user (referring to FIG. 1, 15) registers with the SMS server (19) to obtain a security code or key, which is transmitted either to the mobile station (15) or via email. This can be used to authenticate the rightful owner of the mobile station (15) using the services.

### EXAMPLE THREE

The third example is that of building a user database by means of the present invention. Such a database could for example be one that is used in Example One for the sports club. Once the user database is established it can be used in the manner described above to broadcast target messages (for example marketing and or updates) to members on the database.

Similarly the invention can be used to acquire more information on a customer or client for the database of users. The following example of registration is a particular instance of this example.

### REGISTRATION

Company names 2-20 characters follow by # key

4-8 character for user name follow by # key

Email address follow by # key respond

Age follow by # key

Gender follow by # key

IC number follow by # key

DELI#JEREMY LING#JEREMY@YAHOO.COM#30#M#A3388667#

Thank you XXXXX, welcome to iSMS, we already receive your registration, looking forward for your reply.

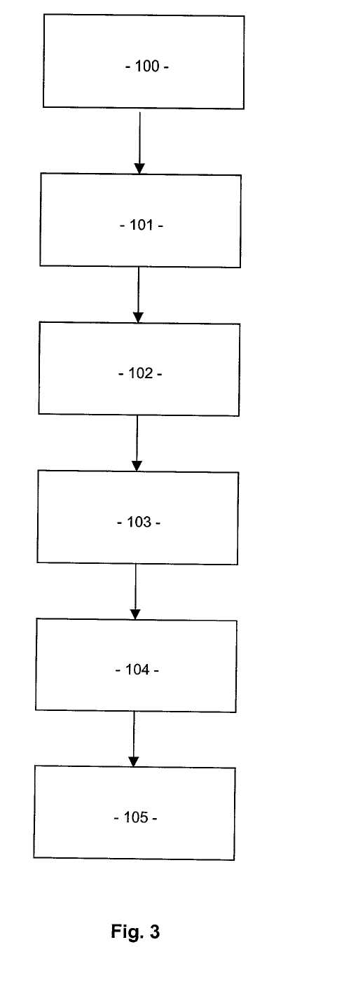

This system is as set out in the flow chart as shown in FIG. 3. The end user registration process (100) starts with a registration (101) as described above. The SMS server responds with an automatic reply (102) requesting a password via SMS. An email (103) and detail for registration is forwarded. This details is entered on the webpage (104) and allows the user to start using the services (105) once the details on the webpage are completed.

### EXAMPLE FOUR

A fourth example is the use of the above described invention for online payment authentication. Frequently a credit card is authenticated online via the use of the card members name, number and card validity date. An ATM card is authenticated by the use of a password.

The above system can be used to validate each of these modes of payments without the need to key in a card number for either system. A password is keyed in as described above and the payments are consolidated to a single monthly account to the user.

For example a buyer orders 1 Compaq's iPaq PDA from eComStore.com costing US$500.00. When the buyer checkout the order, he/she is asked to register with eComStore.com before any checkout can be done.

After that, she is asked to choose the payment mode as follows:

1. Cash on Delivery

2. Credit Card

3. iSMS's iPayment (via Handphone)—Monthly single bill collection

Using iSMS's iPayment, the validation process is as follows:

1. The order info as follows is send via SMS on to the buyer's mobile phone,

Transaction 125D3

eComStore's

Compaq—iPAQ

Price US$500.00

Confirm by forwarding the MSG with YES to 655655

2. The SMS server generates the below message to the buyer.

Transaction 125D3#KeyKJHG12637489KKS88882222DDD2221 #keyinPassword#

Please note: KeyKJHG12637489KKS88882222DDD2221 is a 30 alphanumeric code generated from the Server Engine which encode the Transaction ID, Date, Time, Handphone No. and Server Side key to form the above key.

3. The buyer forwards the above message to 655655 and delete the text “keyinPassword#” and replace it with his/her Password eg. “PW12345#”.

Transaction 125D3#KeyKJHG12637489KKS88882222DDD2221#PW12345#

4. Once the SMS Gateway receives the message, it proofs that the message has been received from the Buyer and the iPayment's Server will decrypt the key and Match the mobile phone No. within the key with the Message's Originating Address(mobile phone number.). It will go through a series of decryption and validation processes before the Payment can be authenticated. Finally, an “ACCEPTED and Delivery Message” is sent to the buyer.

Other examples of uses of this system and method include the following: entry into a competition and draw for same and consolidation of results; information enquiries on the internet; any company wishing to buy and sell services or goods through the internet to a mobile user by use of advertisements templates with an optional feedback system; conducting surveys with a specific template; etc. The list is not, however, meant to be defining or in any way limiting.

Aspects of the present invention have been described by way of examples and it should be appreciated that the concept and principals of the system described are most important but also that modifications and additions may be made thereto without departing from the scope thereof.

TABLE 1

| S/NO | | SEARCH CRITERIA | ABBREVIATION |
|---|---|---|---|
| 1 | Action | BUY | B |
| | | RENT | R |
| | KEY: | TRANSACTED | T |
| | Eg. | BUS SEARCH | BS |
| | BuyHDB => BH | | |
| | RentCondo => RC | | |
| | TransaDetach => TD | | |
| 2 | Type | HDB | H |
| | | HUDC | U |
| | | CONDOMINIUM | C |
| | | PRIVATE APT | P |
| | | SEMI-DETACH | S |
| | | DETACH | D |
| | | TERRACE | T |
| | | BUNGALOW | B |
| | NUMBER OF | HDB TYPE | 2R |
| | ROOM | | 3R, 3I, 3NG, 3ST, 3A, 3S |
| | | | 4R, 4A, 4I, 4S, 4ST, 4NG |
| | | | 5R, 5I, 5S, 5A |
| | | | 6R |
| | | | EM, EA, EC |
| | | OTHERS | 2, 2 + 1, 3, 3 + 1, 4, 4 + 1, 5, 5 + 1, |
| | | | 6, 6 + 1, 7, 7 + 1, 8, 8 + 1, etc. |
| | | ADDRESS/ESTATE | SEE ATTACHED |
| | | BUDGET (MAX) IN | 10,000 = 10 |
| | | THOUSANDS (K) | 100,000 = 100 |
| | | | 1,000,000 = 1000 |
| | | KEY: | 120,000 = 120 |
| | | Eg.(Unit in thousand(k)) | 1,500,000 = 1500 |
| | | $100k => k100 | |
| | | $1 million => k1000 | |
| | | Address | Road Name |
| | | | Area/suburb |
| | | | District |

Query - HDB
Action: Rm: Type: Add: Blk: Budget(Optional)
Query - Condominium/HUDC/PRIVATE APT
Action: Rm: Type: Add: Blk: Budget(Optional)
Query - SEMI-DETACH/DETACH/TERRACE/BUNGALOW
Action: Rm: Type: Add: Blk: Budget(Optional)
Query - BUS SEARCH
Action: From Address: Destination address

[image]

1. A search template for a web portal search engine of the internet, wherein said template is capable of use by a mobile user, said template being in the form of a search index capable of carrying predetermined information and coding instructions and being both capable of use for composing an alphanumeric message for broadcast, and capable of use for interpreting a received message, by the mobile user on a mobile phone, said message being transmitted through a mobile phone network and a server gateway, with electronic transfer of a message to (and from) the said search engine, there being no need for the mobile user to have an internet address.

2. A search template for a web portal search engine of the internet, as claimed in claim 1, wherein said template permits the sending of coded instructions for alteration of content of an internet webpage by one of: addition of information thereon, deletion of information therein and modification of information.

3. A search template for a web portal search engine of the internet as claimed in claim 1, wherein the mobile phone is connected to a mobile phone network which is a GSM network, and the network is connected to a network gateway which is connected to the server gateway.

4. A search template for a web portal search engine of the internet as claimed in claim 3, wherein the network gateway is an SMS server gateway.

5. A search template for a web portal search engine of the internet as claimed in claim 4, wherein the SMS server is the web server for the web portal.

6. A search template for a web portal search engine of the internet as claimed in claim 1, wherein said template is capable of presentation in printed and human-readable format.

7. A search template for a web portal search engine of the internet as claimed in claim 1, wherein said template incorporates coding enabling the addition of security coding to the broadcast message and enabling the decoding of a received broadcast message.

8. A search template for a web portal search engine of the internet as claimed in claim 1, wherein said template incorporates coding for sequential and serial receiving and broadcasting of messages containing information to and from a mobile user, said information in second and subsequent messages being dependent on the information in the first broadcast or received message.

9. A search template for a web portal search engine of the internet as claimed in claim 1, wherein said alpha numeric message, when sent by the mobile user, is generated using a keypad of a mobile phone and the message is broadcast as an SMS message.

10. A method of downloading and uploading information between a mobile phone and the internet, said method including:
providing an internet server gateway for receiving and s ending messages to an mobile network gateway;
providing a template for use by the mobile user, said template being in the form of a search index capable of carrying pre-determined information and coding instruction and being both capable of use for composing an alphanumeric message for broadcast, and capable of use for interpreting a received message, by the mobile user on a mobile phone, said message being transmitted through said mobile phone network and server gateway, with electronic transfer of said message to (and from) the said search engine, there being no need for the mobile user to have an internet address;
using said template for composing and encoding broadcast messages and decoding received messages on the mobile phone.

11. A method of downloading and uploading information between a mobile phone and the internet, as claimed in claim 10, wherein the mobile phone network is a GSM network, and the network is connected to a network gateway which is connected to the server gateway.

12. A method of downloading and uploading information between a mobile phone and the internet, as claimed in claim 10, wherein said template permits the sending of coded instructions for alteration of content of an internet webpage by one of additon of information thereon, deletion of information therein and modification of information.

13. A method of downloading and uploading information between a mobile phone and the internet, as claimed in claim 10, wherein the network gateway is an SMS server gateway.

14. A method of downloading and uploading information between a mobile phone and the internet, as claimed in claim 10, wherein said template is in printed, human readable format.

15. A method of downloading and uploading information between a mobile phone and the internet, as claimed in claim 10, wherein the SMS server is the web server for the web portal.

16. A method of downloading and uploading information between a mobile phone and the internet, as claimed in claim 10, Wherein said template incorporates coding enabling the addition of security coding to the broadcast message and enabling the decoding of a received broadcast message.

17. A method of downloading and uploading information between a mobile phone and the internet, as claimed in claim 10, wherein said method further comprises the step of further using the template to encode a message for broadcast, or for interpreting a message received, wherein said message information is dependent on the content of a previously sent or received message.

18. A method of assembling a database of users, said method including the steps of:
a. downloading information to a mobile phone via the method as claimed in claim 13;
b. uploading a message from a user in response to the information contained in the downloaded message;
c. recording data for a user via a pre-programmed series of instructions on the SMS server;
d. generating an SMS reply to the user for details of registration; and
e. repeating the above four steps for a plurality of users.

19. A method of authentication of information in electronic transfer of funds, said method the step of: operation of the method according to claim 13 wherein said information includes information in the template to key validation of payment and details of payment, said details being stored on the SMS server.
